(19) United States
(12) Patent Application Publication
(10) Pub. No.: US 2025/0230709 A1
(43) Pub. Date: Jul. 17, 2025

(54) MODULAR POCKET SYSTEM

(71) Applicant: Future Sound and Vision Ltd., Hertfordshire (GB)

(72) Inventors: Sam Barnes, St. Albans (GB); Alun Williams, Hitchin (GB)

(21) Appl. No.: 18/415,096

(22) Filed: Jan. 17, 2024

(51) Int. Cl. E06B 9/42; E06B 9/40

(52) U.S. Cl. CPC E06B 9/42; E06B 2009/405

(57) ABSTRACT

A modular pocket system for recessing into a ceiling is provided. The modular pocket system includes a plurality of panels including a top panel, a first side panel, and a second side panel, which are configured to be assembled to form a pocket having at least one lower open face, where each of the plurality of panels is formed of a wood-based material so that the panels can be cut to a desired length prior to assembly. The modular pocket system further includes a plurality of metal profiles including a first side profile configured to be coupled to the first side panel, and a second side profile configured to be coupled to the second side panel or the top panel, where the plurality of metal profiles includes at least one protruding feature for coupling to a component. Methods of building a modular pocket are also provided. The modular pocket system may be used for housing a rolled shade or screen, drapery and/or light fixture.

### FIELD OF THE INVENTION

This disclosure relates to a modular pocket system which may be recessed into a ceiling.

### BACKGROUND

The conventional fabrication of a shade pocket system in a ceiling is typically a multi-step process. First, a builder makes a wooden pocket in the ceiling that is custom-made based upon the specific shade dimensions. Second, a shade installer inserts a standard sized box into the pocket. The box is typically a one piece of extruded aluminum and may be bigger than what is required for a particular shade. After the aluminum box is secured in the pocket, the shade installer installs a rolled shade into brackets positioned on each end of the box.

### SUMMARY

According to a first aspect of the present disclosure. a modular pocket system for recessing into a ceiling is provided. The modular pocket system includes a plurality of panels including a top panel, a first side panel, and a second side panel, which are configured to be assembled to form a pocket having at least one lower open face, where each of the plurality of panels is formed of a wood-based material so that the panels can be cut to a desired length prior to assembly. The modular pocket system also includes a plurality of metal profiles including a first side profile configured to be coupled to the first side panel, and a second side profile configured to be coupled to the second side panel or the top panel, where the plurality of metal profiles includes at least one protruding feature for coupling to a component.

According to another aspect of the present disclosure, a modular pocket shade system for recessing into a ceiling is provided. The modular pocket shade system includes a plurality of panels including a top panel, a first side panel, and a second side panel, which are configured to be assembled to form a pocket having at least one lower open face, where each of the plurality of panels is formed of a wood-based material so that the panels can be cut to a desired length prior to assembly. The modular pocket shade system also includes a plurality of metal profiles including a first side profile configured to be coupled to the first side panel, and a top profile configured to be coupled to the top panel, where the plurality of metal profiles each includes at least one protruding feature for coupling to a component.

According to yet another aspect of the present disclosure, a method of building a modular pocket system for recessing into a ceiling is provided. The method includes providing a plurality of panels including a top panel, a first side panel, and a second side panel, wherein each of the plurality of panels is formed of a wood-based material, cutting the plurality of panels to a desired length, and assembling the plurality of panels together to form a pocket having at least one open face. The method also includes providing a plurality of metal profiles including a first side profile and a second side profile, where each of the plurality of metal profiles includes at least one protruding feature for coupling to a component, assembling the first side profile onto an inside surface of the first side panel, and assembling the second side profile onto an inside surface of the second side panel.

### BRIEF DESCRIPTION OF THE DRAWINGS

FIG. 1 is an end view of a modular pocket system according to one embodiment;

FIG. 2 is an exploded assembly view of a modular pocket system according to one embodiment;

FIG. 3 is another exploded assembly view of a modular pocket system according to one embodiment which illustrates three different partial assemblies;

FIG. 4 is a perspective view of a modular pocket system according to one embodiment;

FIG. 5 is an end view of one embodiment of a modular pocket system installed in a ceiling;

FIG. 6 is an end view of another embodiment of a modular pocket system installed in a ceiling;

FIG. 7 is an end view of another embodiment of a modular pocket system installed in a ceiling;

FIG. 8 is an end view of another embodiment of a modular pocket system;

FIG. 9 is a detailed end view of one embodiment of a modular pocket system that includes a vertical skim trim;

FIG. 10 is a detailed end view of one embodiment of a modular pocket system that includes a flush trim;

FIG. 11 is a detailed end view of one embodiment of a modular pocket system that includes a horizontal skim trim;

FIG. 12 is an end view of one embodiment of a modular pocket system that is configured to hold two rolled shades;

FIG. 13 is a detailed end view of a portion of the modular pocket system shown in FIG. 12;

FIGS. 14A-14C illustrate on embodiment of a modular pocket system having a plurality of first side profiles with a plurality of joiner bars coupling the first side profiles together; and

FIGS. 15A-15B illustrate one embodiment of a bracket illustrating a height adjusting bolt according to one embodiment.

### DETAILED DESCRIPTION

The present disclosure is directed to a modular pocket system. As discussed in more detail below, in one embodiment, the modular pocket system may be used to hold a rolled shade within a ceiling. When in a rolled position, the shade may be fully enclosed within the pocket system such that it is not visible. In an unrolled position, the shade may extend downwardly from the pocket system to cover a window. One of ordinary skill in the art will appreciate that a conventional motor and remote control may be provided to automatically adjust the shade from the rolled position to the unrolled position, yet it is also contemplated that the shade may be rolled/unrolled manually, as the disclosure is not so limited. As discussed in more detail below, in another embodiment, the modular pocket system disclosed may be configured to hold one or more accessories other than a shade, such as, but not limited to one or more screens, lights, or draperies.

Applicant recognized that the conventional approaches of fabricating a pocket system can be laborsome and time consuming. As mentioned above, typically a builder first makes a custom-made wooden pocket in the ceiling, and thereafter, the shade installer installs a three-sided extruded aluminum box that fits into the pocket, and finally, the shade is secured to brackets on the box. The shade manufacturer may make and sell a wide variety of sizes of extruded aluminum boxes to fit the specific dimensions of the pocket.

Applicant also recognized that it is inefficient to manufacture so many different sized extruded boxes, and that it is also expensive to ship the bulky three-sided aluminum boxes from the manufacturing facility to the desired installation location.

Accordingly, as set forth in more detail below, Applicant has developed a modular pocket system that solves some of the problems associated with the conventional pocket systems. In one embodiment, the present disclosure is directed to a modular pocket system which may combine the above-mentioned: 1. custom-made pocket; and 2. the box, into one modular pocket system. In one embodiment, the modular pocket system is made of a plurality of panels that can be shipped in a flat pack system to greatly reduce shipping costs and may also prevent damage during shipping. In one embodiment, the plurality of panels is formed of a wood-based material so that the panels may be cut to a desired length prior to assembly, thus eliminating the need for the shade manufacturer to manufacture many different sized large, extruded boxes. Additionally, the modular pocket system of the present disclosure may remove the need for the builder to first build the custom-made pocket in the ceiling, greatly simplifying the overall process and making it easier for the builder. Additional advantages to the modular pocket system will be discussed in more detail below.

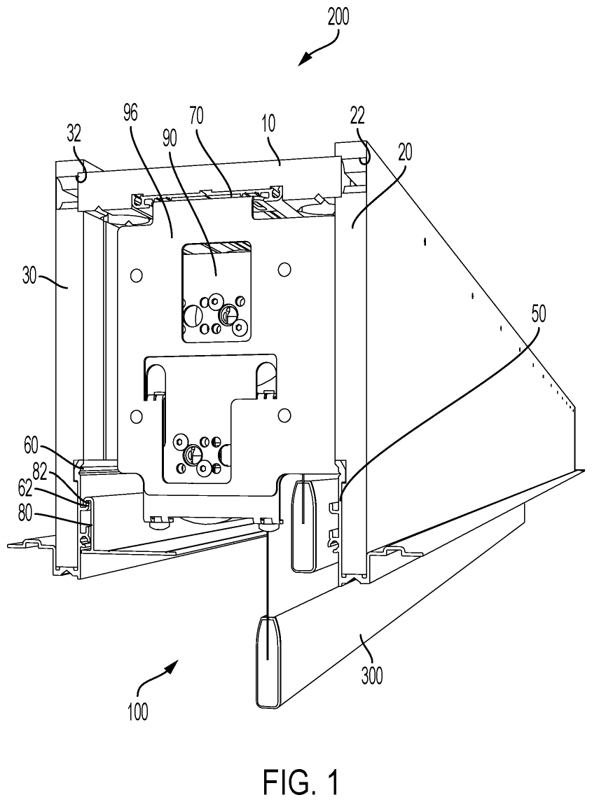

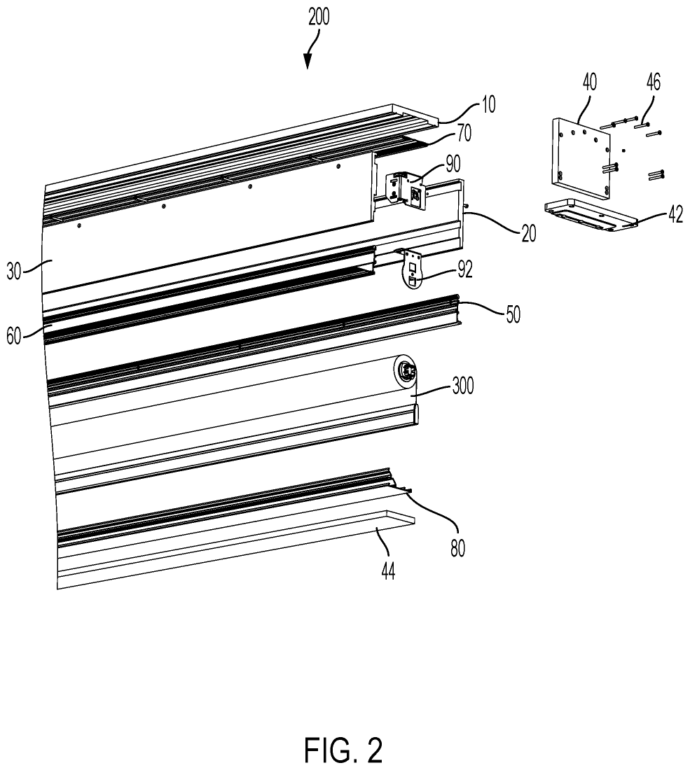

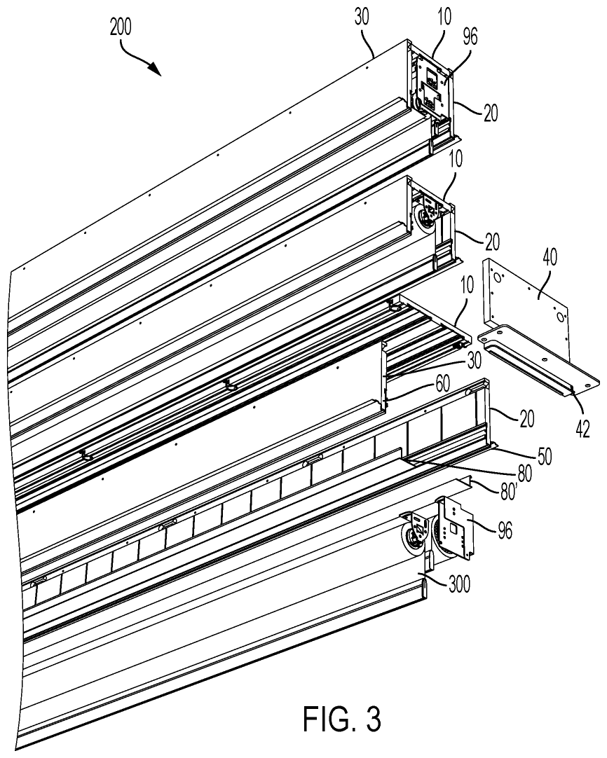

Turning now to FIGS. 1-3, one embodiment of a modular pocket system 200 will now be more fully described. FIG. 1 illustrates an end view of the modular pocket system 200, and FIGS. 2 and 3 both illustrate exploded assembly views of a modular pocket system 200. In one embodiment, the pocket system 200 includes a plurality of panels including a top panel 10, a first side panel 20, and a second side panel 30, which are configured to be assembled to form a pocket having at least one lower open face 100, as shown in FIG. 1. As shown in FIG. 1, the modular pocket system 200 may be configured to hold a shade 300, and in this particular figure, a portion of the shade 300 is shown extending downwardly from the open face 100.

As shown in FIG. 2, the pocket system 200 also includes a plurality of metal profiles 50, 60 including a first side profile 50 configured to be coupled to the first side panel 20, and a second side profile 60 configured to be coupled to second side panel 30. As set forth in more detail below, the plurality of metal profiles 50, 60 includes at least one protruding feature 62 for coupling to a component. For example, as shown in FIG. 1, the second side profile 60 includes a protruding feature 62 which is a hook configured for coupling to another component, such as a cover profile 80. As shown in FIG. 1, in one embodiment, the cover profile 80 is configured to at least partially enclose the open face 100 of the pocket. Further details regarding the protruding feature 62, the cover profile 80 and its coupling to the second side profile 60 are discussed more below.

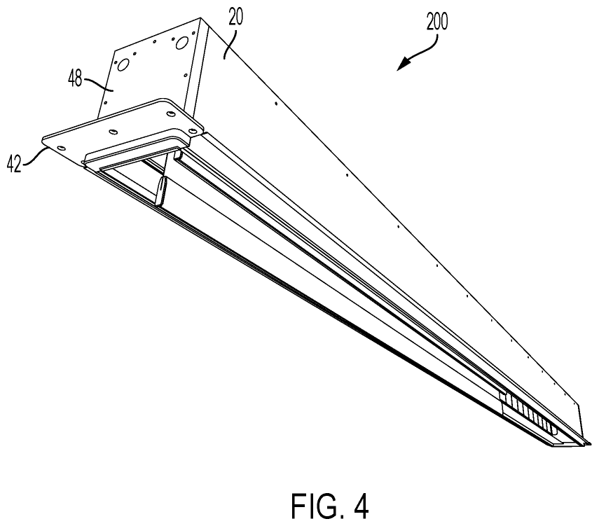

As shown in FIGS. 2-4, the modular pocket system 200 may include a plurality of) end plates 40, 48 including a first end plate 40 configured to be assembled to a first end of the plurality of panels 10, 20, 30, and a second end plate 48 (see FIG. 4) configured to be assembled to the second end of the plurality of panels 10, 20, 30. As shown in FIG. 1, in one embodiment, the plurality of panels 10, 20, 30 form a substantially upside down U-shaped pocket having an open lower face 100.

As set forth in more detail below, the plurality of panels 10, 20, 30 are formed of a wood-based material so that the panels can be cut to a desired length L (see FIG. 4) prior to assembly. A variety of wood-based materials are contemplated below, but in one particular embodiment, the plurality of panels 10, 20, 30 are made of fiberboard, such as moisture resistant medium-density fiberboard (MR MDF). In one embodiment, the end plates 40 may also be made of a wood-based material so that it can also be cut/trimmed to a desired size before assembly. In another embodiment, the panels 10, 20, 30 and/or the end plates 40, 48 may be made of other wood-based materials such as, but not limited to other types of fiberboards, plywood, softwoods, hardwoods, engineered woods, and gypsum board. In another embodiment, the end plates 40, 48 may be made of metal depending on the installation type. The plurality of metal profiles 50, 60 may be made of a variety of different metal materials, but in one embodiment, they are made of an extruded aluminum (i.e., aluminium). In another embodiment, the plurality of metal profiles 50, 60 may be made of other metal materials such as, but not limited to steel, such as mild steel or stainless steel. In one embodiment, the length L of the plurality of panels 10, 20, 30 may be between about 3 feet and about 10 feet. It should be appreciated that the panels 10, 20, 30, may be easily cut to size while on site while flat and assembled easily thereafter using standard hand tools.

In one embodiment, the plurality of panels 10, 20, 30 include notches 22, 32 for assembling the panels 10, 20, 30 together. For example, as shown in FIG. 1, in one embodiment, the first side panel 20 has a notch 22 configured to receive a portion of the top panel 10, and the second side panel 30 has a notch 32 configured to receive a portion of the top panel 10. In one particular embodiment, the notches 22, 32 are channels extending along the length of the first and second side panels 20, 30, and the top panel 10 is received within the channels/notches 22, 32 to secure the plurality of panels 10, 20, 30 together in an interlocking manner. As shown in FIG. 2, a plurality of screws 46, or other fasteners known to one of ordinary skill in the art, may be provided to secure the plurality of panels 10, 20, 30 and end plates 40 together to form the modular pocket system 200. It should be appreciated that pre-drilled holes may be provided in the plurality of panels 10, 20, 30 and end plates 40 to align the screws into the panels/plates. Furthermore, screws or other fasteners may be provided to secure the metal profiles 50, 60 to the panels 10, 20, 30.

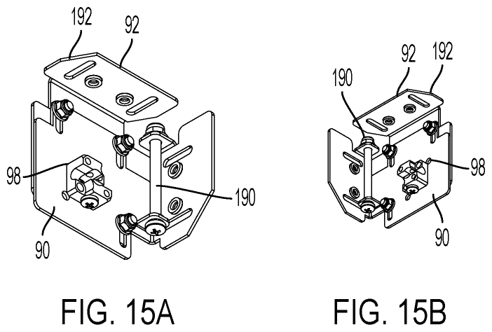

As shown in FIGS. 1-3, in one embodiment, the modular pocket system 200 includes a bracket mounting profile 70 configured to be coupled to the top panel 10. A bracket 90, 92 may also be provided to be coupled to the bracket mounting profile 70, and the bracket 90, 92 may be configured to hold a rolled shade 300 or screen within the pocket. In one illustrative embodiment, the bracket includes a first bracket component 90, and a second bracket component 92. As discussed in more detail below, the first bracket component 90 may be configured to be coupled to the bracket mounting profile 70, and a second bracket component 92 may be configured to hold the rolled shade 300 or screen. As shown in FIGS. 1 and 3, the bracket may also include a bracket plate 96 which may be coupled to the end plate 40. In one embodiment, first bracket component 90 and bracket plate 96 may be part of a bracket assembly which may be provided in a shade mount bracket. Further details regarding the bracket are discussed below and shown in FIGS. 15A and 15B.

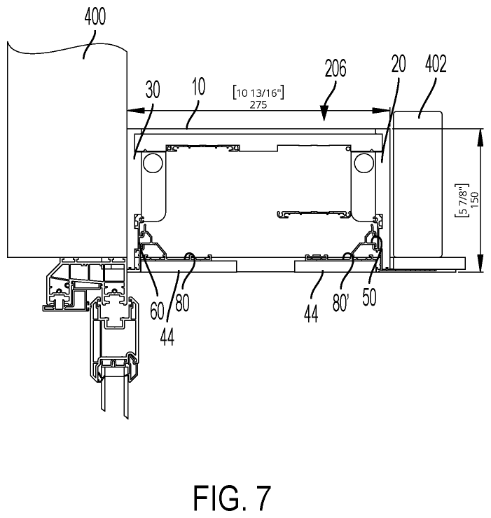

As mentioned above, a cover profile 80 may be provided, and the second side profile 60 may include a protruding feature 62 configured for coupling to the cover profile 80. As shown in FIG. 1, the cover profile 80 may include at least one protruding feature 82 which is configured to engage with the at least one protruding feature 62 on the second side profile 60 to couple the cover profile 80 to the second side profile 60. In one embodiment, the protruding features 62, 82 are hook-shaped extensions, but in another embodiment, the protruding feature may be shaped differently such as, but not limited to various angled, straight, or curved features that extend outwardly from the plane of the metal profile 50, 60. As shown in FIG. 3 (and also FIG. 7 discussed below), in another embodiment, there may be a first cover profile 80′ configured to be coupled to the first side profile 50 to at least partially enclose the open face 100 of the pocket, and a second cover profile 80 configured to be coupled to the second side profile 60 to at least partially enclose the open face 100 of the pocket. As shown, when there are first and second cover profiles 80′, 80, there is still an opening therebetween so that the shade 300 (or other accessory) may extend downwardly from the pocket 200.

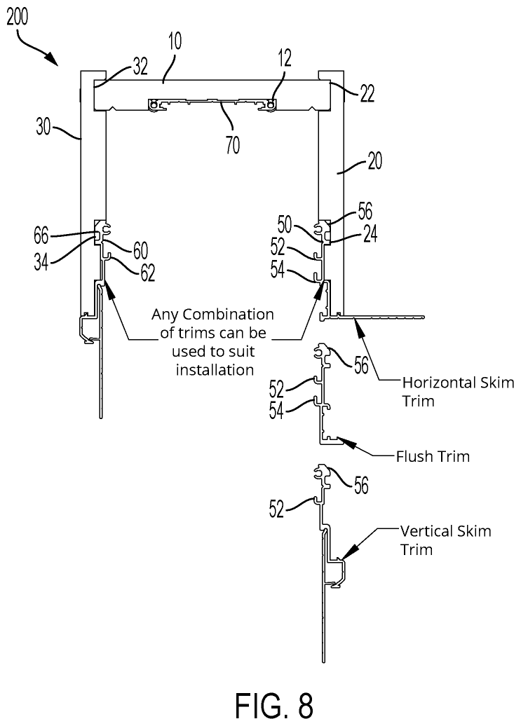

As shown in FIG. 1, in one embodiment, the cover profile 80 is configured to at least partially enclose the open face 100 of the pocket. It should be appreciated that the cover profile 80 may be configured to make the modular pocket system 200 seamlessly fit into the ceiling construction. As shown in FIG. 2, in one embodiment, a finishing material 44 may be coupled to the lower portion of the cover profile 80 to blend into the ceiling. Furthermore, as shown in FIG. 2, a finishing material 42 may be coupled to one or both of the end plates 40, 48 to further provide a seamless fit into the ceiling construction. For example, in one embodiment, the finishing material 42 and end plate 40 design provides a seamless installation into a plastered ceiling without the need for mitering. This horizontal skim trim concept is discussed in more detail below and is also illustrated in FIGS. 8 and 11.

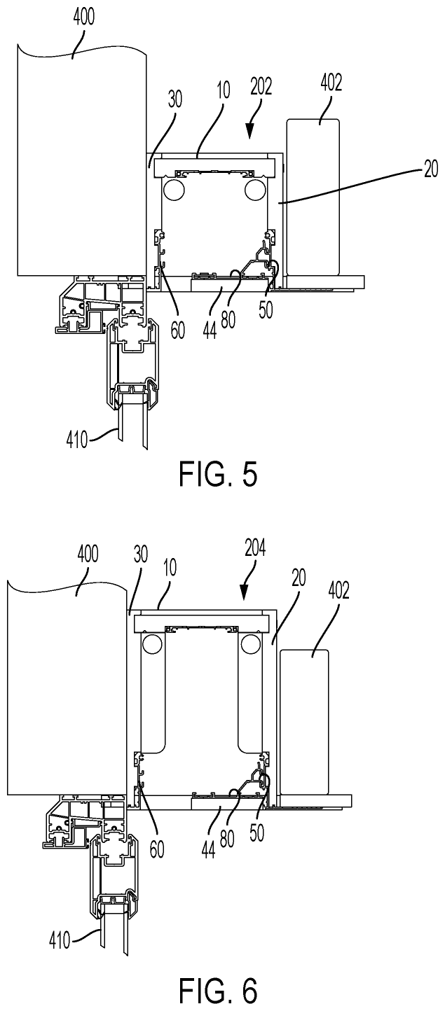

Turning now to FIGS. 5-7, various embodiments of modular pocket systems 202, 204, 206 installed in a ceiling will now be described. As shown, each of these modular pocket systems 202, 204, 206 vary in dimensions and show that the plurality of panels 10, 20, 30 can be cut to a desired length and/or width prior to assembly and installation into the ceiling. As shown, the modular pocket systems 202, 204, 206 may each be sized to fit between adjacent ceiling components 400, 402. In one illustrative embodiment, ceiling component 400 may form a portion of the outer wall of a building adjacent a window 410, and the modular pocket system 202, 204, 206 may be configured to hold a shade 300 configured to selectively cover the window 410. In one illustrative embodiment, the ceiling component 402 may be a horizontal ceiling support beam. As shown, the first side panel 20 is configured to be coupled to the ceiling component 402 and the second side panel 30 is configured to be coupled to the ceiling component 400. One of ordinary skill in the art will appreciate that a variety of known mechanical fasteners may be used to couple the modular pocket system 202, 204, 206 to the ceiling components 400, 402 to install the pocket system in the ceiling. As shown in FIGS. 5 and 6, in one embodiment, the modular pocket system 202, 204 is configured to hold one shade, and as shown in FIG. 7, in one embodiment, the modular pocket system 206 is configured to hold a plurality of shades.

FIGS. 5-7 also illustrate different arrangements of the above-described plurality of metal profiles 50, 60 including the first side profile 50 coupled to the first side panel 20 and the second side profile 60 coupled to the second side panel 30. As shown, the first and second profiles 50, 60 each include protruding features, such as hooks, which are configured to engage adjacent components. For example, as mentioned above, first side profile 50 is configured to engage cover profile 80. In one embodiment, the top panel 10 is about 6 inches wide and the first and second side panels 20, 30 are between about 5 inches-8 inches in height.

As shown in FIG. 7, in another embodiment which is configured to hold multiple shades, the modular pocket system 206 may include a wider top panel 10 which may, for example, be about 11 inches wide. As shown in FIG. 7, a first cover profile 80′ may be coupled to the first side profile 50 to at least partially enclose the open face 100 of the pocket, and a second cover profile 80 may be configured to be coupled to the second side profile 60 to at least partially enclose the open face 100 of the pocket. As discussed above, both the first and second cover profiles 80′, 80 may include at least one protruding feature which is configured to respectively engage a protruding feature on the first and second side profiles 50, 60.

FIG. 8 illustrates the plurality of metal profiles in greater detail. As mentioned above and as shown in FIGS. 1 and 8, in one embodiment, the first side panel 20 has a notch 22 configured to receive a portion of the top panel 10, and the second side panel 30 has a notch 32 configured to receive a portion of the top panel 10. As shown in FIG. 8, the first and second side panels 20, 30 may also include respective notches 24, 34 configured to receive the first and second side profiles 50, 60. More specifically, first side panel 20 may include one or more notches 24, which may be configured as a channel to receive the first side profile 50, and as shown, the first side profile 50 may include a protruding feature 56 configured to fit within the notch 24. Similarly, the second side panel 30 may include one or more notches 34, which may be configured as a channel to receive the second side profile 60, and as shown, the second side profile 60 may include a protruding feature 66 configured to fit within the notch 34. Furthermore, as shown in FIG. 8, the top panel 10 may have one or more notches 12, which may be configured as a channel to receive the bracket mounting profile 70. As shown in FIG. 8, in one embodiment, the protruding features 56, 66 may have an angled edge to facilitate insertion of the metal profile 50, 60 into its respective panel 20, 30.

As shown in FIG. 8, the first side profile 50 has an outer surface and an opposite inner surface facing the inside of the pocket, wherein the outer surface of the first side profile 50 has at least one protruding feature 56 configured to engage with the notch 24 on the first side panel 20, and wherein the inner surface of the first side profile 50 has at least one protruding feature 52, 54 for coupling to a component. As set forth in more detail below, in one embodiment, the protruding features 52, 54 include two hooks to provide two vertically offset positions to couple the cover profile 80.

As shown in FIGS. 8-11, the design and configurations of the metal profiles may vary based upon the desired application. For example, as shown in FIGS. 8 and 11, in one embodiment, one or more of the first and second side profiles 50, 60 may be configured as a horizontal skim trim. As shown, in addition to the above-mentioned profile features, the horizontal skim trim includes a portion that extends around a lower end of the first side panel 20 and outside of the pocket in a substantially horizontal orientation, such that the overall shape of the side profile 50 is substantially L-shaped.

As shown in FIGS. 8 and 10, in another embodiment, one or more of the first and second side profiles 50, 60 may be configured as a flush trim. As shown, the flush trim also includes a portion that extends around a lower end of the first side panel 20 in a substantially horizontal orientation that does not extend passed the first side panel 20. Accordingly, the overall shape of the side profile 50 is substantially L-shaped, but the horizontal portion is much shorter in comparison to the horizontal skim trim profile. It should be appreciated that in an embodiment which includes the horizontal portion, the metal profile may be secured to the adjacent ceiling components from below.

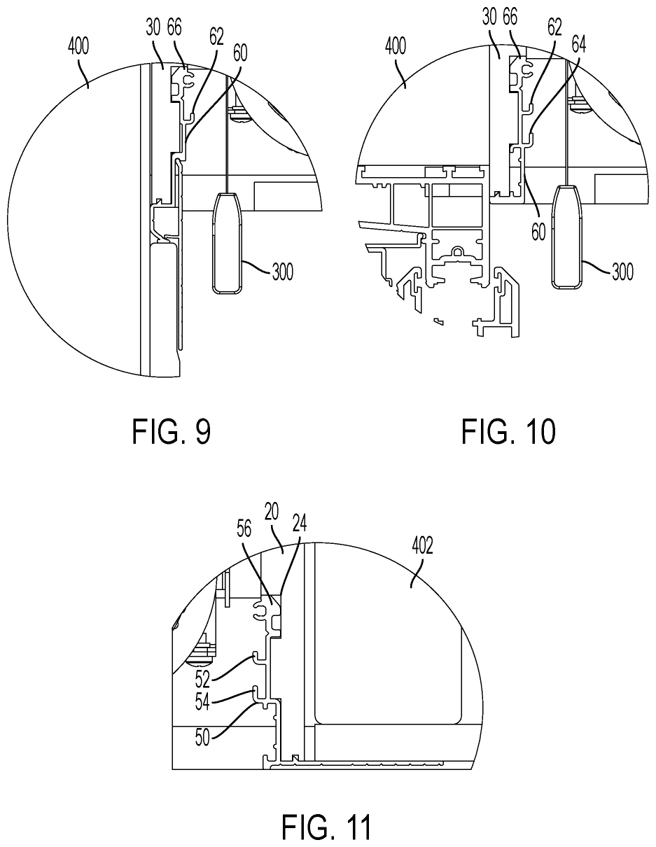

As shown in FIGS. 8 and 9, in another embodiment, one or more of the first and second side profiles 50, 60 may be configured as a vertical skim trim. As shown, the vertical skim trim profile includes the above-mentioned protruding features 52, 56, but it does not include a horizontal portion which extends around a lower end of the first side panel 20. It should be appreciated that any of the above mentioned trim/profile configurations may be used in the modular pocket system 200 based upon the particular installation requirements and/or desired design.

Applicant recognized that the horizontal and vertical skim trim configurations provide a plaster skim edge detail as well as a dual position hook on flap in one product allowing for a quick way to create a seamless finish from ceiling to pocket. Furthermore, in one embodiment, by fixing from below through slotted holes in the horizontal skim trim, the skim trim can be perfectly aligned with the ceiling without the need to remove and realign. Additionally, the combination of the metal profiles and the wood-based panels provides a stable straight edge to pocket where the flap meets the ceiling. Once the skim trim is installed, it can be plastered to create a seamless finish.

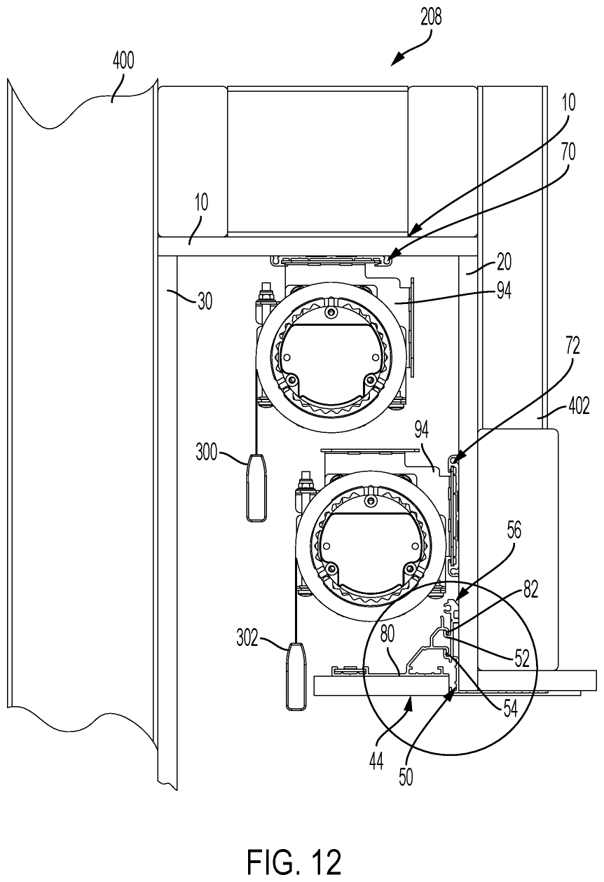

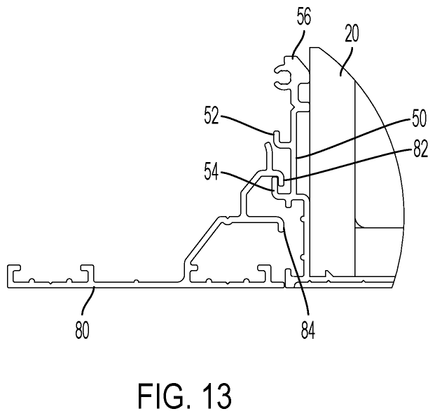

Turning now to FIGS. 12-13, yet another embodiment of a modular pocket system 208 which holds a plurality of rolled shades 300, 302 will now be described. As discussed above, the modular pocket system 208 may include a top profile (i.e., bracket mounting profile 70) coupled to the top panel 10, and a bracket 94 may also be provided to be coupled to the bracket mounting profile 70, where the bracket 94 is configured to hold a rolled shade 300 or screen within the pocket. As shown, the modular pocket system 208 may include a second bracket mounting profile 72 coupled to the first side panel 20, and a second bracket 94 may also be provided to be coupled to the second bracket mounting profile 72, where the second bracket 94 is configured to hold a second rolled shade 302 or screen within the pocket. As shown, in this particular configuration, the shades 300, 302 are substantially stacked so that the second rolled shade 302 is positioned below the first shade 300.

FIGS. 12 and 13 also illustrate a cover profile 80 configured to be coupled to the first side profile 50 to at least partially enclose the open face 100 of the pocket. As shown, the cover profile 80 has at least one protruding feature 82 which is configured to engage with a protruding feature 52 on the first side profile 50 to couple the cover profile 80 to the first side profile 50.

In one illustrative embodiment, the at least one protruding feature 52, 54 on the first side profile 50 includes at least two hooks 52, 54 to provide two vertically offset positions to couple the cover profile 80. In FIG. 12, the protruding feature 82 is coupled to the upper hook 52 so that the cover profile 80 is in an elevated vertical position such that a finishing material 44 may be coupled to the underside of the cover profile 80 and the finishing material 44 is flush with the bottom of the side panel 20. In contrast, in FIG. 13, the protruding feature 82 is coupled to the lower hook 54 so that the cover profile 80 is in a lowered position such that the underside of the cover profile 80 is flush with the bottom of the side panel 20. In one embodiment, the protruding features 52, 54, 82, 84 are hook-shaped extensions, but in another embodiment, the protruding feature may be shaped differently such as, but not limited to various angled, straight, or curved features that extend outwardly from the plane of the metal profile 50, 80.

It should be appreciated that these two vertically offset positions provide more versatility to the installer when installing the modular pocket system 208 in a ceiling. As shown, in one embodiment, the at least one protruding feature on the first side profile 50 includes at least two hooks 52, 54, and the at least one protruding feature on the cover profile 80 includes at least two hooks 82, 84 to provide two spaced apart locations for the cover profile 80 to engage with the first side profile 50. Applicant recognized that in one embodiment, the two-hook design may provide a more stable configuration for supporting a heavier load which, as discussed above, may include a finishing material 44. In one embodiment, additional fixings/protruding features may be provided on the metal profiles to add strength to hang heavier flap materials (such as cover profile 80 and finishing material 44).

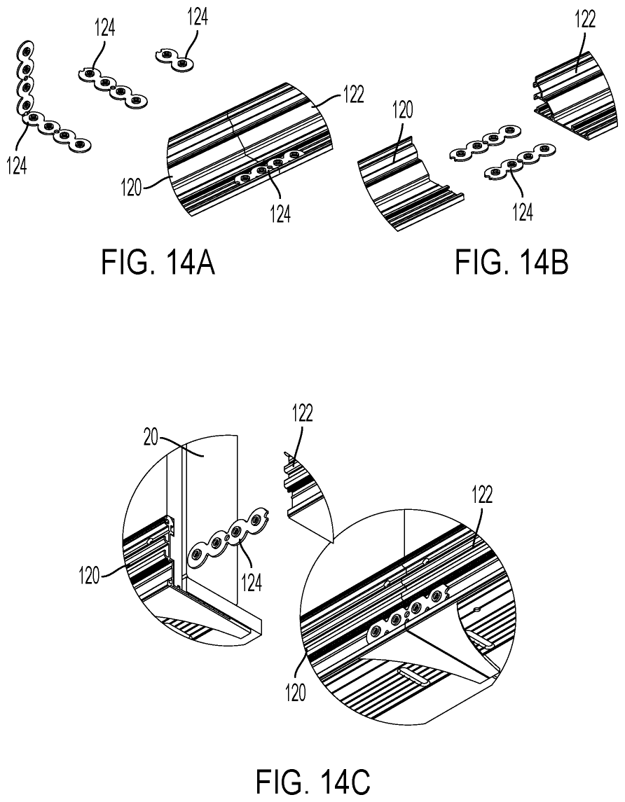

As mentioned above, the modular pocket system includes a plurality of metal profiles 50, 60, 70 which are configured to be coupled to the first side panel 20, second side panel 30, and/or the top panel 10. As shown in FIGS. 14A-14C, in one embodiment, the modular pocket system 200 may include a plurality of first side profiles 120, 122. As shown in FIG. 4, the first panel 20 has a length L, and the plurality of first side profiles 120, 122 may extend end to end, in a substantially linear arrangement along the length of the first panel 20. As shown in FIGS. 14A-14C, a plurality of joiner bars 124 may couple the plurality of first side profiles 120, 122 together. As shown, joiner bars 124 may be included in the modular pocket system for joining any of the metal profiles together. As shown, the joiner bars 124 may slide within channels formed within the metal profiles to interlock two adjacent metal profiles together. Although FIGS. 14A-14C illustrate side profiles 120, 122, it should be appreciated that the joiner bars 124 may be used in connection with any of the metal profiles, including but not limited to the first side profile 50, the second side profile 60, the bracket mounting profile 70, and/or the cover profile 80, as the disclosure is not so limited. Furthermore, as shown in FIG. 14A, the joiner bars 124 may be configured in substantially straight segments and/or in substantially L-shaped segments for corners.

As mentioned above, in one embodiment, the above-described modular pocket system is configured to hold a shade 300 and may include a bracket to hold the shade 300. The present disclosure contemplates that the modular pocket system may be used to hold other accessories/equipment, besides shades, including, but not limited to various screens, lights and/or drapery/curtains. It is contemplated that the pocket system may include a bracket or track which is configured to hold any combination of these items, as the disclosure is not so limited. It is contemplated that it may be desirable to place the modular pocket system in the ceiling near a window so that the shade 300 can selectively cover the window. In another embodiment, the modular pocket system may be placed in the ceiling to house a projection screen. In one embodiment the modular pocket system is configured to hold a plurality of accessories, for example, a shade 300, a drapery, and one or more lights to accent the shade and drapery. It is contemplated that the modular pocket system may have many uses in both home and commercial applications.

FIGS. 15A-15B illustrate one embodiment of a bracket 90, 92 configured to hold a rolled shade 300 or screen within the modular pocket system 200. In one embodiment, the bracket 90,92 is configured to be coupled to the bracket mounting profile 70, as shown in FIGS. 1, 2, 8 and 12. As shown in FIGS. 15A and 15B, in one embodiment, the bracket 90, 92 may include a first bracket component 90 configured to be coupled to the bracket mounting profile 70, and a second bracket component 92 configured to hold the roller shade 300 or screen. As shown, the second bracket component 92 may include a protruding component 98 configured to engage with an end of a rolled shade 300. In one embodiment, one bracket is positioned at a first end of the modular pocket system 200 to engage with a first end of the roller shade, and a second bracket is positioned at a second end of the modular pocket system to engage with a second end of the roller shade 300. It should be appreciated that in another embodiment, the bracket may be configured differently, and the bracket design may vary based upon the specific design of the rolled shade or screen. As mentioned above, the bracket may also be designed for use with a conventional motor which may automate the movement of the shade from a rolled position to an unrolled position.

As shown in FIGS. 15A-15B, in one embodiment, the bracket 90, 92 may include an angled edge 192 configured so that the bracket 90, 92 twists into the bracket mounting profile 70. In one embodiment, the bracket 90, 92 may be configured to twist into place within the mounting profile 70 without the use of a tool. Once installed, the upper portion of the bracket may be retained within the mounting profile 70. It should be recognized that in one embodiment, the bracket mounting profile 70 may be configured as a rail that extends across the top panel 10 of the modular pocket system 200. As shown in FIG. 12, in one embodiment, the bracket mounting profile 72 may be configured as a rail that extends across one of the side panels 20, 30 of the modular pocket system 200.

Applicant recognized that it may be desirable to adjust the bracket 90, 92 to level the rolled shade 300 or screen while the rolled shade or screen is positioned within the pocket. This may be necessary to compensate for an unlevel ceiling. Thus, as shown in FIGS. 15A-15B, in one embodiment, a height-adjusting bolt 190 may be positioned between the first and second bracket components 90, 92 which is configured to raise/lower the bracket. As shown, the placement of the height-adjusting bolt 190 enables a user to adjust the shade from below without having to remove a shade 300 from the brackets. The Applicant recognized that this was desirable because it eliminates the installer from having to perform an extra step of removing the shade 300 when one or both brackets require vertical adjustment.

The present disclosure also contemplates methods of building a modular pocket system for recessing into a ceiling. In one embodiment, the method includes providing a plurality of panels including a top panel 10, a first side panel 20, and a second side panel 30, where each of the plurality of panels 10, 20, 30 is formed of a wood-based material. The method includes cutting the plurality of panels 10, 20, 30 to a desired length, and assembling the plurality of panels 10, 20, 30 together to form a pocket having at least one open face 100. The method also includes providing a plurality of metal profiles including a first side profile 50 and a second side profile 60, where each of the plurality of metal profiles includes at least one protruding feature 52, 62 for coupling to a component, assembling the first side profile 50 onto an inside surface of the first side panel 20, and assembling the second side profile 60 onto an inside surface of the second side panel 30.

The method may further include providing a bracket mounting profile 70, assembling the bracket mounting profile 70 to the top panel 10, providing a bracket 90, 92, 96 configured to hold a rolled shade 300 or screen, and assembling the bracket 90, 92, 96 to the bracket mounting profile 70. In one embodiment, the step of assembling the bracket 90, 92, 96 to the bracket mounting profile 70 includes twisting the bracket 90, 92, 96 into the bracket mounting profile 70.

The method may also include providing a first cover profile 80 having at least one protruding feature 82, assembling the first cover profile 80 to the first side profile 50 to at least partially enclose the open face 100 of the pocket, where the at least one protruding feature 82 of the first cover profile 80 engages with the at least one protruding feature 52 on the first side profile 50.

Furthermore, the method may also include providing a second cover profile 80′ having at least one protruding feature 82 and assembling the second cover profile 80′ to the second side profile 60 to at least partially enclose the open face 100 of the pocket, where the at least one protruding feature 82 of the second cover profile 80′ engages with the at least one protruding feature 62 on the second side profile 60.

As discussed above, the present disclosure has many advantages over the conventional shade pocket systems. First, Applicant recognized that by incorporating wood-based materials (such as fiberboard) to form the panels 10, 20, 30, the product may greatly reduce thermal and noise transmission. Second, Applicant recognized that this modular and flexible product design allows for significant customization while also minimizing waste and environmental impact when comparing to the conventional full aluminum pocket systems. Also, as mentioned above, this present disclosure eliminates the need for making plywood framing in the ceiling to accept the shade pocket system, thus saving time and money on site. This reduces workflow on site to create ceiling recesses for shades and other similar equipment. Furthermore, the two-position flap/hook design on the side metal profiles 50, 60 incorporates two height positions for the cover profile 80 allowing greater flexibility on site with less parts. Finally, the mounting rail system design allows for infinite adjustment of shade brackets and other suitable hardware using the twist-in feature with no need for drilling.

Although several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. Those skilled in the art will recognize or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto; the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

All references, patents and patent applications and publications that are cited or referred to in this application are incorporated in their entirety herein by reference.

1. A modular pocket system for recessing into a ceiling, the modular pocket system comprising:
a plurality of panels including a top panel, a first side panel, and a second side panel, which are configured to be assembled to form a pocket having at least one lower open face, wherein each of the plurality of panels is formed of a wood-based material so that the panels can be cut to a desired length prior to assembly; and
a plurality of metal profiles including a first side profile configured to be coupled to the first side panel, and a second side profile configured to be coupled to the second side panel or the top panel, wherein the plurality of metal profiles includes at least one protruding feature for coupling to a component.

2. The modular pocket system of claim 1, further comprising:
a plurality of end plates including a first end plate configured to be assembled to a first end of the plurality of panels, and a second end plate configured to be assembled to a second end of the plurality of panels.

3. The modular pocket system of claim 1, further comprising:
a cover profile configured to be coupled to the first side profile to at least partially enclose the open face of the pocket, wherein the cover profile has at least one protruding feature which is configured to engage with the at least one protruding feature on the first side profile to couple the cover profile to the first side profile.

4. The modular pocket system of claim 3, wherein the at least one protruding feature on the first side profile includes at least two hooks to provide two vertically offset positions to couple the cover profile.

5. The modular pocket system of claim 3, wherein the at least one protruding feature on the first side profile includes at least two hooks, and the at least one protruding feature on the cover profile includes at least two hooks to provide two spaced apart locations for the cover profile to engage with the first side profile.

6. The modular pocket system of claim 1, wherein the plurality of wood-based panels is made of fiberboard.

7. The modular pocket system of claim 1, wherein the plurality of metal profiles is made of aluminum.

8. The modular pocket system of claim 1, wherein the plurality of panels includes notches for assembling the panels together.

9. The modular pocket system of claim 1, wherein the first side panel includes a notch, and wherein the first side profile has an outer surface and an opposite inner surface facing the inside of the pocket, wherein the outer surface of the first side profile has at least one protruding feature configured to engage with the notch on the first side panel, and wherein the inner surface of the first side profile has at least one protruding feature for coupling to a component.

10. The modular pocket system of claim 1, further comprising:
a bracket mounting profile configured to be coupled to the top panel; and
a bracket configured to be coupled to the bracket mounting profile, wherein the bracket is configured to hold a rolled shade or screen within the pocket.

11. The modular pocket system of claim 10, wherein the bracket has an angled edge configured so that the bracket twists into the bracket mounting profile.

12. The modular pocket system of claim 10, wherein the bracket comprising:
a first bracket component configured to be coupled to the bracket mounting profile;
a second bracket component configured to hold the rolled shade or screen; and
a height adjusting bolt positioned between the first and second bracket components configured to level the rolled shade or screen while the rolled shade or screen is positioned within the pocket.

13. The modular pocket system of claim 1, wherein the pocket is configured to house a bracket or track which is configured to hold a shade, screen, light, or drapery.

14. The modular pocket system of claim 1, further comprising:
a plurality of first side profiles, wherein the first panel has a length, and wherein the plurality of first side profiles extends in a substantially linear arrangement along the length of the first panel; and
a plurality of joiner bars coupling the plurality of first side profiles together.

15. The modular pocket of claim 1, wherein the first and second side profiles are configured to be coupled, respectively, to the first and second side panels adjacent the open face of the pocket, and wherein a portion of each of the first and second side profiles extends around a lower end of the first and second side panels and outside of the pocket.

16. A modular pocket shade system for recessing into a ceiling, the modular pocket shade system comprising:
a plurality of panels including a top panel, a first side panel, and a second side panel, which are configured to be assembled to form a pocket having at least one lower open face, wherein each of the plurality of panels is formed of a wood-based material so that the panels can be cut to a desired length prior to assembly; and
a plurality of metal profiles including a first side profile configured to be coupled to the first side panel, and a top profile configured to be coupled to the top panel, wherein the plurality of metal profiles each includes at least one protruding feature for coupling to a component.

17. The modular pocket shade system of claim 16, wherein the top profile is a bracket mounting profile configured to receive a bracket configured to hold a rolled shade or screen within the pocket.

18. The modular pocket shade system of claim 16, further comprising:
a first cover profile configured to be coupled to the first side profile to at least partially enclose the open face of the pocket, wherein the first cover profile has at least one protruding feature which is configured to engage with the at least one protruding feature on the first side profile to couple the first cover profile to the first side profile.

19. The modular pocket shade system of claim 18, further comprising:
wherein the plurality of metal profiles includes a second side profile configured to be coupled to the second side panel, and
a second cover profile configured to be coupled to the second side profile to at least partially enclose the open face of the pocket, wherein the second cover profile has at least one protruding feature which is configured to engage with at least one protruding feature on the second side profile to couple the second cover profile to the second side profile.

20. A method of building a modular pocket system for recessing into a ceiling, the method comprising:
providing a plurality of panels including a top panel, a first side panel, and a second side panel, wherein each of the plurality of panels is formed of a wood-based material;
cutting the plurality of panels to a desired length;
assembling the plurality of panels together to form a pocket having at least one open face;
providing a plurality of metal profiles including a first side profile and a second side profile, wherein each of the plurality of metal profiles includes at least one protruding feature for coupling to a component;
assembling the first side profile onto an inside surface of the first side panel; and
assembling the second side profile onto an inside surface of the second side panel.

21.-24. (canceled)
